(19) United States
(12) Patent Application Publication
(10) Pub. No.: US 2024/0311976 A1
(43) Pub. Date: Sep. 19, 2024

(54) IMAGE CORRECTION MODEL TRAINING METHOD AND APPARATUS, IMAGE CORRECTION METHOD AND APPARATUS, AND COMPUTER DEVICE

(71) Applicant: TENCENT TECHNOLOGY (SHENZHEN) COMPANY LIMITED, Shenzhen (CN)

(72) Inventors: Yuanyuan ZHAO, Shenzhen (CN); Jian ZHANG, Shenzhen (CN); Yingying FU, Shenzhen (CN); Hao LIU, Shenzhen (CN); Chen LI, Shenzhen (CN)

(21) Appl. No.: 18/671,582

(22) Filed: May 22, 2024

Related U.S. Application Data
(63) Continuation of application No. PCT/CN2023/099636, filed on Jun. 12, 2023.

(30) Foreign Application Priority Data
Aug. 25, 2022 (CN) 202211025023.9

(51) Int. Cl. G06T 5/60; G06T 5/50; G06V 10/26; G06V 10/764; G06V 10/774; G06V 10/776; G06V 10/82

(52) U.S. Cl. CPC G06T 5/60; G06T 5/50; G06V 10/26; G06V 10/764; G06V 10/774; G06V 10/776; G06V 10/82; G06T 2207/10016; G06T 2207/20081; G06T 2207/20084; G06T 2207/20221

(57) ABSTRACT

This application relates to an image correction model training method including obtaining a training image, and performing random data distortion on the training image to obtain a distorted image and distortion parameter information; inputting the distorted image into an initial image correction model to predict a correction parameter, to obtain initial correction parameter information, and performing image correction on the distorted image to obtain an initial corrected image; calculating a loss between the initial correction parameter information and correction parameter information corresponding to the distortion parameter information, to obtain parameter loss information, and calculating a loss between the training image and the initial corrected image to obtain image loss information; updating the initial image correction model to obtain an updated image correction model; and performing training and obtaining the updated image correction model iteratively, until a target image correction model is obtained when a training completion condition is reached.

### RELATED APPLICATIONS

This application is a continuation of PCT Application No. PCT/CN2023/099636, filed on Jun. 12, 2023, which in turn claims priority to Chinese Patent Application No. 2022110250239, entitled “IMAGE CORRECTION MODEL TRAINING METHOD AND APPARATUS, IMAGE CORRECTION METHOD AND APPARATUS, AND COMPUTER DEVICE” filed with the China National Intellectual Property Administration on Aug. 25, 2022. The applications are incorporated by reference in their entirety.

### FIELD OF THE TECHNOLOGY

This application relates to the field of image processing technologies, and in particular, to an image correction model training method and apparatus, an image correction method and apparatus, a computer device, a storage medium, and a computer program product.

### BACKGROUND OF THE DISCLOSURE

With the development of image processing technologies, an image editing technology has emerged, that is, images may be corrected through image editing. For example, images may be corrected by adjusting the saturation, contrast, white balance, color temperatures, exposure, and the like. During image correction, information such as average image brightness, average image response contrast, and average image response distribution histogram is usually calculated, and then the average information is compared with preset standard information and then converted into an image brightness adjustment parameter, an image contrast adjustment parameter, and the like for image correction. However, the method of determining correction parameters by comparing average information with standard information results in low accuracy and poor effect of image correction.

### SUMMARY

Based on this, in view of the above technical problems, it is necessary to provide an image correction model training method and apparatus, an image correction method and apparatus, a computer device, a computer-readable storage medium, and a computer program product that can improve the accuracy of image correction.

One aspect of this application provides an image correction model training method. The method includes obtaining a training image, and performing random data distortion based on the training image, to obtain a distorted image and distortion parameter information; inputting the distorted image into an initial image correction model to predict a correction parameter, to obtain initial correction parameter information, and performing image correction on the distorted image based on the initial correction parameter information, to obtain an initial corrected image; calculating a loss between the initial correction parameter information and correction parameter information corresponding to the distortion parameter information, to obtain parameter loss information, and calculating a loss between the training image and the initial corrected image to obtain image loss information; updating the initial image correction model based on the parameter loss information and the image loss information, to obtain an updated image correction model; and using the updated image correction model as the initial image correction model, and performing training and obtaining the updated image correction model iteratively, until a target image correction model is obtained when a training completion condition is reached, the target image correction model being configured for performing image correction on the inputted image to obtain a target corrected image.

Another aspect of this application provides an image correction method. The method includes obtaining a to-be-corrected image; inputting the to-be-corrected image into a target image correction model to predict a correction parameter to obtain correction parameter information corresponding to the to-be-corrected image, the target image correction model being obtained by: performing random data distortion based on a training image, to obtain a distorted image and distortion parameter information; inputting the distorted image into an initial image correction model to predict a correction parameter, to obtain initial correction parameter information, and performing image correction on the distorted image based on the initial correction parameter information, to obtain an initial corrected image; calculating a loss between the initial correction parameter information and correction parameter information corresponding to the distortion parameter information, to obtain parameter loss information, and calculating a loss between the training image and the initial corrected image to obtain image loss information; updating the initial image correction model based on the parameter loss information and the image loss information, to obtain an updated image correction model; and using the updated image correction model as the initial image correction model, and repeating above training steps iteratively to obtain a distorted image and distortion parameter information, until a training completion condition is satisfied; and performing image correction on the to-be-corrected image based on the correction parameter information, to obtain a target corrected image.

Another aspect of this application provides a computer device. The computer device includes a memory and a processor, the memory stores computer-readable instructions, and the processor executes the computer-readable instructions to perform the following operations: obtaining a training image, and performing random data distortion based on the training image, to obtain a distorted image and distortion parameter information; inputting the distorted image into an initial image correction model to predict a correction parameter, to obtain initial correction parameter information, and performing image correction on the distorted image based on the initial correction parameter information, to obtain an initial corrected image; calculating a loss between the initial correction parameter information and correction parameter information corresponding to the distortion parameter information, to obtain parameter loss information, and calculating a loss between the training image and the initial corrected image to obtain image loss information; updating the initial image correction model based on the parameter loss information and the image loss information, to obtain an updated image correction model; and using the updated image correction model as the initial image correction model, and performing training and obtaining the updated image correction model iteratively, until a target image correction model is obtained when a training completion condition is reached, the target image correction model being configured for performing image correction on the inputted image to obtain a target corrected image.

In the above image correction model training method and apparatus, the computer device, the storage medium, and the computer program product, random data distortion is performed based on a training image, to obtain a distorted image and distortion parameter information. The distorted image is inputted into an initial image correction model to predict a correction parameter, to obtain initial correction parameter information, and image correction is performed on the distorted image based on the initial correction parameter information, to obtain an initial corrected image. A loss between the initial correction parameter information and correction parameter information corresponding to the distortion parameter information is calculated, to obtain parameter loss information, and a loss between the training image and the initial corrected image is calculated to obtain image loss information. The initial image correction model is updated based on the parameter loss information and the image loss information, to obtain an updated image correction model. The updated image correction model is used as the initial image correction model, and loop iteration is performed until a target image correction model is obtained when a training completion condition is reached. That is, the initial image correction model is updated by calculating parameter loss information and image loss information and loop iteration is performed, so that the target image correction model obtained through training is more accurate. Then, the target correction parameter information is predicted through the target image correction model, which improves the accuracy of the target correction parameter information. Then, image correction is performed on the input image based on the target correction parameter information, to obtain the target corrected image, thereby improving the accuracy of the obtained target corrected image. Besides, by performing image correction on the image, the texture of the obtained target corrected image is improved, and the overall image looks more natural.

Further, in the above image correction method and apparatus, the computer device, the storage medium, and the computer program product, the to-be-corrected image is inputted into a target image correction model to predict a correction parameter to obtain correction parameter information corresponding to the to-be-corrected image, the target image correction model being obtained by performing random data distortion based on the training image, to obtain a distorted image and distortion parameter information; inputting the distorted image into an initial image correction model to predict a correction parameter, to obtain initial correction parameter information, and performing image correction on the distorted image based on the initial correction parameter information, to obtain an initial corrected image; calculating a loss between the initial correction parameter information and correction parameter information corresponding to the distortion parameter information, to obtain parameter loss information, and calculating a loss between the training image and the initial corrected image to obtain image loss information; updating the initial image correction model based on the parameter loss information and the image loss information, to obtain an updated image correction model; and using the updated image correction model as the initial image correction model, and performing loop iteration, until a training completion condition is reached. Image correction is performed on the to-be-corrected image based on the correction parameter information, to obtain the target corrected image, thereby improving the accuracy of the obtained target corrected image, that is, improving the accuracy of the image correction. By performing image correction on the to-be-corrected image, the texture of the obtained target corrected image is improved, and the overall image looks more natural.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1 is a diagram of an application environment of an image correction model training method according to an embodiment of the present disclosure;

FIG. 2 is a schematic flowchart of an image correction model training method according to an embodiment of the present disclosure;

FIG. 3 is a schematic flowchart of obtaining discriminant loss information according to an embodiment of the present disclosure;

FIG. 4 is a schematic flowchart of obtaining an initial image discriminator network according to an embodiment of the present disclosure;

FIG. 5 is a schematic diagram of a training framework of an image correction model according to an embodiment of the present disclosure;

FIG. 6 is a schematic diagram of a training framework of an image correction model according to an embodiment of the present disclosure;

FIG. 7 is a schematic flowchart of an image correction method according to an embodiment of the present disclosure;

FIG. 8 is a schematic diagram of video correction according to an embodiment of the present disclosure;

FIG. 9 is a schematic diagram of obtaining a fusion correction image according to an embodiment of the present disclosure;

FIG. 10 is a schematic flowchart of an image correction method according to an embodiment of the present disclosure;

FIG. 11 is a structural block diagram of an image correction model training apparatus according to an embodiment of the present disclosure;

FIG. 12 is a structural block diagram of an image correction apparatus according to an embodiment of the present disclosure;

FIG. 13 is a diagram of an internal structure of a computer device according to an embodiment of the present disclosure; and

FIG. 14 is a diagram of an internal structure of a computer device according to an embodiment of the present disclosure.

### DESCRIPTION OF EMBODIMENTS

To make the objectives, technical solutions, and advantages of this application clearer, the following further describes this application in detail with reference to the accompanying drawings and the embodiments. The specific embodiments described herein are only used for explaining this application, and are not used for limiting this application.

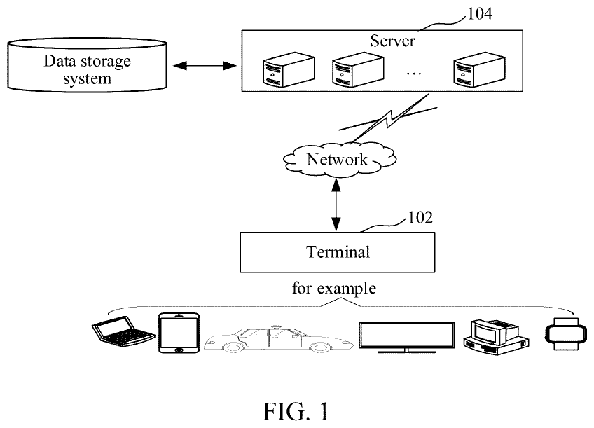

An image correction model training method provided in an embodiment of this application may be applied to an application environment shown in FIG. 1. A terminal 102 communicates with a server 104 by using a network. A data storage system may store data that needs to be processed by server 104. The data storage system may be integrated in server 104, or placed on the cloud or other servers. The server 104 receives a model training instruction sent by the terminal 102, obtains a training image from a data storage system, and performs random data distortion based on the training image, to obtain a distorted image and distortion parameter information. The server 104 inputs the distorted image into an initial image correction model to predict a correction parameter, to obtain initial correction parameter information, and performs image correction on the distorted image based on the initial correction parameter information, to obtain an initial corrected image. The server 104 calculates a loss between the initial correction parameter information and correction parameter information corresponding to the distortion parameter information, to obtain parameter loss information, and calculates a loss between the training image and the initial corrected image to obtain image loss information. The server 104 updates the initial image correction model based on the parameter loss information and the image loss information, to obtain an updated image correction model. The server 104 uses the updated image correction model as the initial image correction model, and returns to iteratively perform the operation of obtaining a training image, and performing random data distortion based on the training image, to obtain a distorted image and distortion parameter information, until a target image correction model is obtained when a training completion condition is reached, the target image correction model being configured for predicting a correction parameter of an inputted image to obtain target correction parameter information, and the target correction parameter information being configured for performing image correction on the inputted image to obtain a target corrected image. The terminal 102 may be but is not limited to various personal computers, laptops, smartphones, tablets, IoT devices, and portable wearable devices. The IoT devices may include smart speakers, smart televisions, smart air conditioners, smart in-vehicle devices, or the like. The portable wearable devices may be smart watches, smart bracelets, head-mounted devices, and the like. The server 104 may be implemented by using an independent server or a server cluster that includes multiple servers.

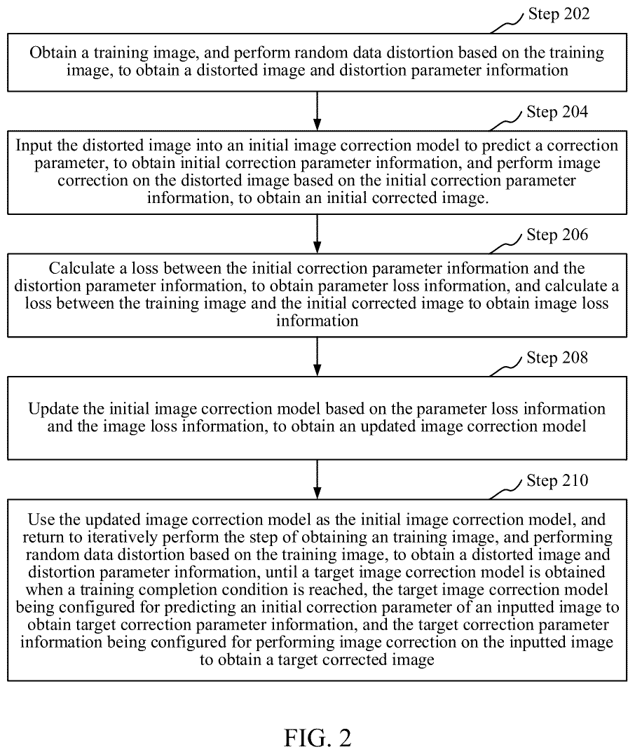

In an embodiment, as shown in FIG. 2, an image correction model training method is provided. The application of this method to the server in FIG. 1 is used as an example for illustration. This method may also be applied to a terminal, and may also be applied to a system including a terminal and a server, and is implemented through the interaction between a terminal and a server. In this embodiment, the method includes the following operations:

Operation 202: Obtain a training image, and perform random data distortion based on the training image, to obtain a distorted image and distortion parameter information.

The training image refers to an image used during training, and the training image is a normal image and an image without distortion. A distorted image refers to an image obtained after random data distortion. The distorted image is an image that needs to be corrected, or an image obtained after negative optimization, and may be an image with distortion. Distortion parameter information refers to image parameter information used to negatively adjust the training image. An image parameter includes but is not limited to saturation, contrast, white balance, a color temperature, exposure, brightness and other parameters that are used to adjust the image. The negative adjustment may be adjusting a normal image parameter of a normal image to an image parameter of a distorted image. For example, the image parameter of the normal image may be increased to obtain a distorted image, or the image parameter of the normal image may be decreased to obtain a distorted image. The distorted image may also be an image with an irregular image distribution caused because saturation, contrast, white balance, a color temperature, exposure, brightness, and other parameters set during shooting are inappropriate. That is, the distorted image may be an image with distorted image quality. Random data distortion refers to negatively adjusting a normal image based on randomly generated distortion parameter information, that is, adjusting a normal image to obtain a distorted image. For example, a randomly generated distortion parameter may be an increase of exposure of a normal image by 100% or decrease of brightness of a normal image by 50%.

Specifically, the server may obtain training images from a database or from a server that provides data services. The server may also obtain training images uploaded by the terminal. The server may also obtain training images provided by a service party. Then, negative optimization is performed on the training image to obtain training image pairs, including normal training images and images that need to be corrected by negative optimization. The server may obtain the distorted image by performing random data distortion on the training image, and obtain the distortion parameter information used during the random data distortion. The distortion parameter information is randomly generated. For example, an exposure negative adjustment parameter may be randomly generated, and the exposure of the training image is adjusted based on the exposure negative adjustment parameter, to obtain the adjusted image, that is, the distorted image. Alternatively, various negative adjustment parameters may be randomly generated, and the exposure of the training image is adjusted based on all randomly generated negative adjustment parameters, to obtain the adjusted image, that is, the distorted image.

Operation 204: Input the distorted image into an initial image correction model to predict a correction parameter, to obtain initial correction parameter information, and perform image correction on the distorted image based on the initial correction parameter information, to obtain an initial corrected image.

The initial image correction model refers to an image correction model with initialized model parameters. The image correction model is configured for predicting correction parameter information of the input image. The correction parameter information is information of the image parameter used to correct the distorted image. The distorted image may be positively adjusted based on the correction parameter information, to obtain a normal image. The image parameter may include but is not limited to saturation, contrast, white balance, a color temperature, exposure, brightness and other parameters that may be used to adjust the image. Model parameter initialization may be random initialization, zero initialization, Gaussian distribution initialization, or the like. The initial correction parameter information refers to correction parameter information obtained by predicting the distorted image through the initial image correction model of the initialized parameters. The initial correction parameter information has an error relative to real correction parameter information, and needs to be continuously optimized and iterated. The initial corrected image refers to the image obtained by correcting the distorted image based on the initial correction parameter information.

Specifically, the server establishes a model architecture of the image correction model by using a neural network. The neural network may be a convolutional neural network, a recurrent neural network, a deep belief neural network or a generative adversarial neural network, or the like. The model architecture of the image correction model may also be obtained from a combination of multiple neural networks. The parameter of the model is initialized to obtain the initial image correction model. Then, the initial image correction model is trained. That is, the distorted image is used as the input of the initial image correction model, and initialized parameters in the initial image correction model are used to predict correction parameters, thereby obtaining outputted initial correction parameter information. Then, image correction is performed on the distorted image based on the initial correction parameter information, to obtain an initial corrected image.

Operation 206: Calculate a loss between the initial correction parameter information and the distortion parameter information, to obtain parameter loss information, and calculate a loss between the training image and the initial corrected image to obtain image loss information.

The parameter loss information is configured for representing an error between predicted correction parameter information and real correction parameter information. The real correction parameter information may be obtained based on the distortion parameter information, where the real correction parameter information may be calculated based on the distortion parameter information. That is, the inverse number of each parameter value in the distortion parameter information is calculated to obtain the correction parameter information. For example, if the distortion parameter information includes increase of the exposure of the normal image by 100%, the image correction parameter information obtained by calculating the inverse number includes decrease of the exposure of the normal image by 100%. For example, if the distortion parameter information includes doubling the brightness of the normal image, the image correction parameter information obtained by calculating the inverse number includes decrease of the brightness value of the normal image by half. The smaller the parameter loss information is, the more accurate the predicted correction parameter information is. The image loss information is configured for representing the error between the initial corrected image and the training image. The smaller the image loss information, the higher the accuracy of image correction, and the more accurate the predicted correction parameter information.

Specifically, the server determines the corresponding correction parameter information based on the distortion parameter information, and uses, as a label during training, the correction parameter information corresponding to the distortion parameter information. Then, the error between the initial correction parameter information and the correction parameter information corresponding to the distortion parameter information is calculated based on a loss function, to obtain the parameter loss information, and the error between the initial corrected image and the training image is calculated based on a loss function, to obtain the image loss information. The loss function may be a regression loss function. For example, the function may be a distance loss function or an absolute value loss function.

Operation 208: Update the initial image correction model based on the parameter loss information and the image loss information, to obtain an updated image correction model.

The updated image correction model refers to an image correction model obtained after the model parameters are updated.

Specifically, the server calculates gradient information based on the parameter loss information and the image loss information according to a gradient descent algorithm, updates the initialization parameters in the initial image correction model based on the gradient information, and obtains the updated image correction model when all the initialization parameters in the initial image correction model are updated.

Operation 210: Use the updated image correction model as the initial image correction model, and return to iteratively perform the operation of obtaining a training image, and performing random data distortion based on the training image, to obtain a distorted image and distortion parameter information, until a target image correction model is obtained when a training completion condition is reached, the target image correction model being configured for predicting a correction parameter of an inputted image to obtain target correction parameter information, and the target correction parameter information being configured for performing image correction on the inputted image to obtain a target corrected image.

The training completion condition refers to a condition for obtaining the target image correction model through training, and includes but is not limited to the training loss information reaches a preset threshold or the number of training iterations reaches the maximum number of iterations or the model parameters no longer change. The target image correction model refers to an image correction model that has been trained. The input image refers to an image that needs to be corrected, and the correction refers to adjusting the image. The target correction parameter information refers to correction parameter information corresponding to the input image. Different images have different target correction parameter information. The target corrected image refers to an image obtained after correcting the input image. Image correction refers to a process of adjusting a distorted image, that is, an image with distorted image quality, to obtain a normal image. For example, an overexposed distorted image may be adjusted to obtain a corrected image. The exposure of the corrected image is normal. Alternatively, a distorted image with poor exposure may be adjusted to obtain a corrected image, and the exposure of the corrected image is normal.

Specifically, when determining whether the training completion condition is met, for example, the server may determine whether the parameter loss information and the image loss information reach a preset loss threshold, or determine whether the number of training iterations reaches a maximum number of iterations, or determine whether model parameters do not change after multiple iterations. When the training completion condition is not reached, the server may use the updated image correction model as the initial image correction model, and return to iteratively perform the operation of obtaining a training image, and performing random data distortion based on the training image, to obtain a distorted image and distortion parameter information, that is, continuously update and iterate parameters in the image correction model, until the target image correction model is obtained when the training completion condition is reached. The server may predict the correction parameter of the inputted image through the target image correction model, to obtain the target correction parameter information, and then perform image correction on the inputted image based on the target correction parameter information, to obtain the target corrected image.

In the above image correction model training method, random data distortion is performed based on the training image, to obtain the distorted image and the distortion parameter information. The distorted image is inputted into an initial image correction model to predict a correction parameter, to obtain initial correction parameter information, and image correction is performed on the distorted image based on the initial correction parameter information, to obtain an initial corrected image. Loss calculation is performed based on the initial correction parameter information and the distortion parameter information, to obtain parameter loss information, and loss calculation is performed based on the training image and the initial corrected image, to obtain image loss information. The initial image correction model is updated based on the parameter loss information and the image loss information, to obtain an updated image correction model. The updated image correction model is used as the initial image correction model, and loop iteration is performed until a target image correction model is obtained when a training completion condition is reached. That is, the initial image correction model is updated by calculating parameter loss information and image loss information and loop iteration is performed, so that the target image correction model obtained through training is more accurate. Then, the target correction parameter information is predicted through the target image correction model, which improves the accuracy of the target correction parameter information. Then, image correction is performed on the inputted image based on the target correction parameter information, to obtain the target corrected image, thereby improving the accuracy of the obtained target corrected image. Besides, by performing image correction on the image, the texture of the obtained target corrected image is improved and the overall image looks more natural.

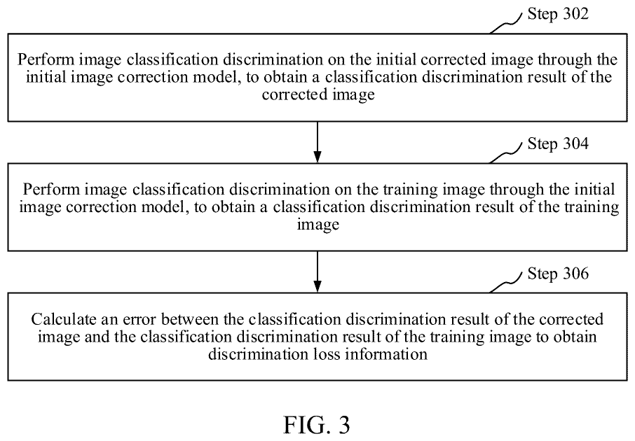

In an embodiment, as shown in FIG. 3, after operation 204, that is, after the inputting the distorted image into an initial image correction model to predict a correction parameter, to obtain initial correction parameter information, and performing image correction on the distorted image based on the initial correction parameter information, to obtain an initial corrected image, the method further includes:

Operation 302: Perform image classification and discrimination on the initial corrected image through the initial image correction model, to obtain a classification and discrimination result of the corrected image.

Operation 304: Perform image classification and discrimination on the training image through the initial image correction model, to obtain a classification and discrimination result of the training image.

Operation 306: Calculate an error between the classification and discrimination result of the corrected image and the classification and discrimination result of the training image to obtain discriminant loss information.

Image classification and discrimination is used to perform identification of two categories of images. The two categories of images include images in a normal category and images in a distortion category. Images in a distortion category refer to images that need to be corrected. The discriminant loss information is used to represent the error in image classification and discrimination. When the error represented by the discriminant loss information is smaller, it indicates that the corrected image output by the image correction model is closer to a real normal image. The classification and discrimination result of the corrected image refers to a result of performing identification of two categories of images on the initial corrected image, that is, it is identified whether the initial corrected image is an image in a normal category or an image in a distortion category. The classification and discrimination result of the training image refers to a result of performing identification of two categories of images on the training image, that is, it is identified whether the training image is an image in a normal category or an image in a distortion category.

Specifically, the server may perform image classification and discrimination through the initial image correction model, that is, the initial image correction model also includes initialization parameters for classification and discrimination of images. That is, the initialized image classification and discrimination parameter may be used to perform image classification and discrimination on the initial corrected image, to obtain the classification and discrimination result of the corrected image. The classification and discrimination result of the corrected image may include a probability that the initial corrected image is an image in a normal category or a probability that the initial corrected image is an image in a distortion category. Then, the initialized image classification and discrimination parameter may be used to perform image classification and discrimination on the training image, to obtain the classification and discrimination result of the training image. The classification and discrimination result of the training image may include a probability that the training image is an image in a normal category or a probability that the training image is an image in a distortion category. The classification and discrimination result of the corrected image and the classification and discrimination result of the training image are discrimination results of the same image category. For example, when the classification and discrimination result of the corrected image is a probability that the initial corrected image is an image in a normal category, the classification and discrimination result of the training image is a probability that the training image is an image in a normal category. When the classification and discrimination result of the corrected image is a probability that the initial corrected image is an image in a distortion category, the classification and discrimination result of the training image is a probability that the training image is an image in a distortion category. The server then calculates the error between the classification and discrimination result of the corrected images and the classification and discrimination result of the training image by using a classification loss function, to obtain the discriminant loss information, where the classification loss function may be a cross-entropy loss function.

Operation 208 of updating the initial image correction model based on the parameter loss information and the image loss information, to obtain an updated image correction model includes the following operation:
updating the initial image correction model based on the discriminant loss information, the parameter loss information and the image loss information, to obtain a target updated image correction model.

The target updated image correction model refers to an image correction model obtained by updating the initial image correction model based on the discriminant loss information, that is, an image correction model obtained by updating the initialized image classification and discrimination parameter and the initialized image correction parameter in the initial image correction model.

Specifically, the server calculates a loss information sum of the discriminant loss information, the parameter loss information and the image loss information, and then uses the loss information sum to update the initialized parameter in the initial image correction model, including the initialized image classification discriminant parameter and the initialized image correction parameter, to obtain the target updated image correction model. All the initialized parameters in the initial image correction model may be updated through a gradient descent algorithm, to obtain the target updated image correction model. The gradient descent algorithm may include a batch gradient descent algorithm, a stochastic gradient descent algorithm, and a mini-batch gradient descent algorithm.

In some embodiments, the server may calculate the discriminant loss information by using the following formula (1).

$$\\ \begin{matrix}loss D = - ( D ( {V}_{gt} ) log ( D ( {V}_{out} ) ) + ( 1 - D ( {V}_{gt} ) ) log ( 1 - D ( {V}_{out} ) ) ) . & formula ( 1 )\end{matrix}$$

lossD refers to the discriminant loss information, D(Vₒᵤₜ) refers to the classification and discrimination result of the corrected image and may be a category probability or a category score, and Vₒᵤₜ refers to the corrected image. D(V_{gt}) refers to the classification and discrimination result of the training image and may be a category probability or a category score, and V_{gt} refers to the training image.

In the above embodiment, the classification and discrimination result of the corrected image and the classification and discrimination result of the training image are obtained through image classification and discrimination, and then the error between the classification and discrimination result of the corrected image and the classification and discrimination result of the training image is calculated to obtain the discriminant loss information. Finally, the discriminant loss information, the parameter loss information and the image loss information are used to train the initial image correction model, thereby improving the training accuracy.

In an embodiment, operation 302 of performing image classification and discrimination on the initial corrected image through the initial image correction model, to obtain a classification and discrimination result of the corrected image includes the following operations:
obtaining current model loss information corresponding to the initial image correction model; and when detecting that the current model loss information meets a preset discrimination condition, performing image classification and discrimination on the initial corrected image through the initial image correction model, to obtain the classification and discrimination result of the corrected image.

The current model loss information refers to loss information corresponding to the currently obtained initial image correction model. The loss information includes parameter loss information and image loss information, and may be a sum of the parameter loss information and the image loss information. The discriminant training condition refers to a preset condition for starting discriminant training, and may be that the current model loss information reaches a preset loss threshold.

Specifically, the server obtains the parameter loss information and the image loss information corresponding to the current initial image correction model, and then calculates the loss information sum of the parameter loss information and the image loss information to obtain the current model loss information. Then, the server compares the current model loss information with the discriminant training condition, for example, compares the current model loss information with a preset loss threshold. When the current model loss information meets the preset loss threshold, it indicates that the discriminant training condition is met. When the current model loss information does not meet the preset loss threshold, it indicates that the discriminant training condition is not met. When the current model loss information does not meet the discriminant training condition, normal iterative training continues. When the current model loss information meets the discriminant training condition, it indicates that image discrimination training needs to be started. In this case, the server performs image classification and discrimination on the initial corrected image through the initial image correction model, to obtain the classification and discrimination result of the corrected image, and performs image classification and discrimination on the training image to obtain the classification and discrimination result of the training image.

In an embodiment, when the server detects that when the number of iterations of model training reaches a preset threshold of the number of discrimination iterations, it indicates that the discriminant training condition is met. In this case, image classification and discrimination is performed on the initial corrected image through the initial image correction model, to obtain the classification and discrimination result of the corrected image, and image classification and discrimination is performed on the training image through the initial image correction model to obtain the classification and discrimination result of the training image.

In the above embodiment, when the current model loss information meets the discriminant training condition, the discriminant training is started, that is, image classification and discrimination is performed on the initial corrected image through the initial image correction model, to obtain the classification and discrimination result of the corrected image, and image classification and discrimination is performed on the training image to obtain the classification and discrimination result of the training image. This can further improve the training accuracy while improving training efficiency, and discriminant training is started only when the current model loss information meets the discriminant training condition, which can save training resources and improve training efficiency.

In an embodiment, the initial image correction model includes an initial correction parameter prediction network.

Operation 204 of inputting the distorted image into an initial image correction model to predict a correction parameter, to obtain initial correction parameter information, and performing image correction on the distorted image based on the initial correction parameter information, to obtain an initial corrected image includes the following operations:
inputting the distorted image into an initial correction parameter prediction network to predict the correction parameter, to obtain initial correction parameter information; and performing weighting on the distorted image based on the initial correction parameter information, to obtain the initial corrected image.

The initial correction parameter prediction network refers to a neural network with initialized network parameters. The neural network is configured for predicting an image correction parameter. The neural network may be a convolutional neural network, a feedforward neural network, a recurrent neural network, or the like.

Specifically, the server inputs the distorted image into the initial image correction model. The initial image correction model inputs the distorted image into the initial correction parameter prediction network. The initial correction parameter prediction network predicts the correction parameter for the distorted image to obtain outputted initial correction parameter information. The initial correction parameter information may include various different categories of correction parameters, for example, may include an initial adjustment parameter for saturation, an initial adjustment parameter for contrast, an initial adjustment parameter for white balance, an initial adjustment parameter for a color temperature, and an initial adjustment parameter for exposure. Then, weighting is performed on the distorted image based on the initial correction parameter information, that is, the distorted image is adjusted based on various different categories of correction parameters, to obtain the adjusted image, that is, obtain the initial corrected image. For example, the saturation of the distorted image is adjusted based on an initial adjustment parameter for saturation, then the contrast of the distorted image is adjusted based on an initial adjustment parameter for contrast, the white balance of the distorted image is adjusted based on an initial adjustment parameter for white balance, and the color temperature of the distorted image is adjusted based on an initial adjustment parameter for a color temperature, and the exposure of the distorted image is adjusted based on an initial adjustment parameter for exposure. After the adjustment is completed, an initial corrected image is obtained.

In the above embodiment, a correction parameter is predicted through the initial correction parameter prediction network, and weighting is performed on the distorted image based on the initial correction parameter information, to obtain an initial corrected image, thereby improving the accuracy of the obtained initial corrected image.

In an embodiment, the initial image correction model further includes an initial image discriminator network; and
after the performing weighting on the distorted image based on the initial correction parameter information, to obtain the initial corrected image, the method further includes the following operations:
inputting the initial corrected image into the initial image discriminator network for image classification and discrimination, to obtain a classification and discrimination result of the corrected image; and inputting the training image into the image discriminator network for image classification and discrimination, to obtain a classification and discrimination result of the training image.

The initial image discriminator network is a neural network for image classification and discrimination. The neural network may be a convolutional neural network, a feedforward neural network, a recurrent neural network, or the like. During the training process of the initial image correction model, when the classification and discrimination result of the corrected image outputted by the initial image discriminator network is consistent with the classification and discrimination result of the training images, it indicates that the initial image correction model reaches the training completion condition.

Specifically, during the training process, the server may perform image classification and discrimination after obtaining the initial corrected image, that is, input the initial corrected image into the image discriminator network for image classification and discrimination, to obtain the classification and discrimination result of the corrected image, and input the training image into the image discriminator network for image classification and discrimination, to obtain the classification and discrimination result of the training image. The initial corrected image and the training image may be inputted into the image discriminator network at the same time for image classification and discrimination, or the initial corrected image and the training image may be inputted into the image discriminator network in sequence for image classification and discrimination, to obtain the classification and discrimination result of the corrected image and the classification and discrimination result of the training image. For example, when performing image classification and discrimination on the initial corrected image and the training image at the same time, a probability that the initial corrected image is an image in a normal category and a probability that the training image is an image in a normal category may be outputted.

Operation 208 of updating the initial image correction model based on the parameter loss information and the image loss information, to obtain an updated image correction model includes the following operation:
calculating an error between the classification and discrimination result of the corrected image and the classification and discrimination result of the training image to obtain discriminant loss information; and updating the initial correction parameter prediction network and the initial image discriminator network in the initial image correction model based on the discriminant loss information, the parameter loss information and the image loss information, to obtain a target updated image correction model.

Specifically, the server may calculate the error between the classification and discrimination result of the corrected image and the classification and discrimination result of the training image by using the cross-entropy loss function, to obtain the discriminant loss information, then calculate the loss information sum of the discriminant loss information, the parameter loss information and the image loss information, and use the loss information sum to update the initial correction parameter prediction network and the initial image discriminator network in the initial image correction model, to obtain the updated initial image correction model, that is, obtain the target updated image correction model. Then, the server may use the target updated image correction model as the initial image correction model, and return to iteratively perform the operation of obtaining a training image, and performing random data distortion based on the training image, to obtain a distorted image and distortion parameter information, until the final trained image correction model is obtained when the training completion condition is reached.

In the above embodiment, the initial image discriminator network is added to the initial image correction model, image classification and discrimination is performed through the initial image discriminator network, to obtain the discriminant loss information, and then the discriminant loss information, the parameter loss information and the image loss information are used to update the initial correction parameter prediction network and the initial image discriminator network in the initial image correction model to obtain the target updated image correction model. Therefore, the obtained target updated image correction model is more accurate, thereby making the final trained image correction model more accurate and improving the accuracy of image correction.

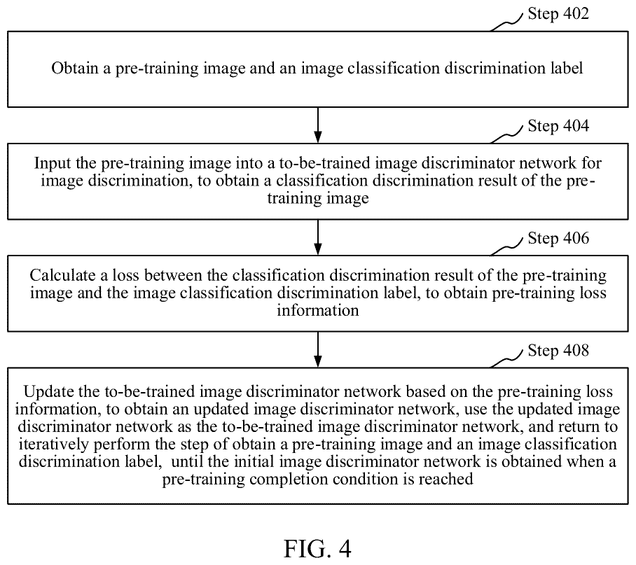

In an embodiment, as shown in FIG. 4, pre-training of the initial image discriminator network includes the following operations:

Operation 402: Obtain a pre-training image and an image classification and discrimination label.

The pre-training image refers to an image used when pre-training the image discriminator network. The pre-training image may be an image in a normal category or an image in a distortion category. The image classification and discrimination label refers to an image category label corresponding to the pre-training image, that is, an image category label corresponding to the image used during pre-training. The image category label includes an image in a normal category label and an image in a distortion category label. Pre-training refers to training by using data in advance so that a model parameter obtained through training has prior knowledge and common sense to some extent, thereby improving the performance on various tasks. By using the model parameter obtained through pre-training as the initialized parameter in the initial image discriminator network, the accuracy of image discrimination may be improved while improving training efficiency.

Specifically, the server may directly obtain the pre-training image and the corresponding image classification and discrimination label from a database. The server may also obtain the pre-training image and the image classification and discrimination label from a service provider that provides data services. The server may also obtain the pre-training image and the image classification and discrimination label uploaded by the terminal. The server may also obtain the pre-training image from a service party, and then obtain the image classification and discrimination label corresponding to the pre-training image.

Operation 404: Input the pre-training image into a to-be-trained image discriminator network for image discrimination, to obtain a classification and discrimination result of the pre-training image.

The to-be-trained image discriminator network refers to an image discriminator network that needs to be pre-trained. The to-be-trained image discriminator network includes a to-be-trained network parameter. The to-be-trained network parameter may be obtained through zero initialization, or may be obtained through random initialization, or may be obtained through Gaussian distribution initialization. The classification and discrimination result of the pre-training image is configured for representing the image category corresponding to the pre-training image. The image category may include an image in a normal category and an image in a distortion category. The classification and discrimination result of the pre-training image may be represented by a category probability. The higher the category probability, the higher the probability that the pre-training image is a corresponding image category.

Specifically, the server uses the training image as the input of the to-be-trained image discriminator network to train the to-be-trained image discriminator network, that is, uses the network parameter in the to-be-trained image discriminator network to perform weighting on the training image to obtain a weighting result, and finally normalizes the weighted result, to obtain the outputted classification and discrimination result of the pre-training image.

Operation 406: Calculate a loss between the classification and discrimination result of the pre-training image and the image classification and discrimination label, to obtain pre-training loss information.

The pre-training loss information is configured for representing the error between the classification and discrimination result of the pre-training image and the corresponding image classification and discrimination label during pre-training.

Specifically, the server calculates the error between the classification and discrimination result of the pre-training image and the image classification and discrimination label by using the classification loss function, to obtain the pre-training loss information. The classification loss function may be a cross-entropy loss function, a logarithmic loss function, an exponential loss function, or a square loss function.

Operation 408: Update the to-be-trained image discriminator network based on the pre-training loss information, to obtain an updated image discriminator network, use the updated image discriminator network as the to-be-trained image discriminator network, and return to iteratively perform the operation of obtaining a pre-training image and an image classification and discrimination label, until the initial image discriminator network is obtained when a pre-training completion condition is reached.

The pre-training completion condition refers to a condition for completing the training of the to-be-trained image discriminator network, and may be that the pre-training loss information reaches a preset loss threshold or the number of iterations of pre-training reaches an upper limit of the number of iterations or the network parameter obtained through training no longer changes.

Specifically, the server first determines whether the pre-training completion condition is met. For example, the pre-training loss information may be compared with the preset loss threshold. When the pre-training loss information exceeds the preset loss threshold, it indicates that the training does not reach the pre-training completion condition. When the pre-training completion condition is not reached, the server updates the network parameter in the to-be-trained image discriminator network based on the pre-training loss information by using the gradient descent algorithm. The gradient descent algorithm may be a full gradient descent algorithm, a stochastic gradient descent algorithm, a stochastic average gradient descent algorithm, a mini-batch gradient descent algorithm, or the like. When the network parameter update is completed, the updated image discriminator network is obtained. Then, the updated image discriminator network is used as the to-be-trained image discriminator network, and returning is performed to iteratively perform the operation of obtaining a pre-training image and an image classification and discrimination label, until when the pre-training completion condition is reached, the image discriminator network obtained when the pre-training completion condition is reached is used as the initial Image discriminator network.

In the above embodiment, the initial image discriminator network is obtained through pre-training, and then the initial image discriminator network is used to train the image correction model, which can improve the training efficiency of the image correction model.

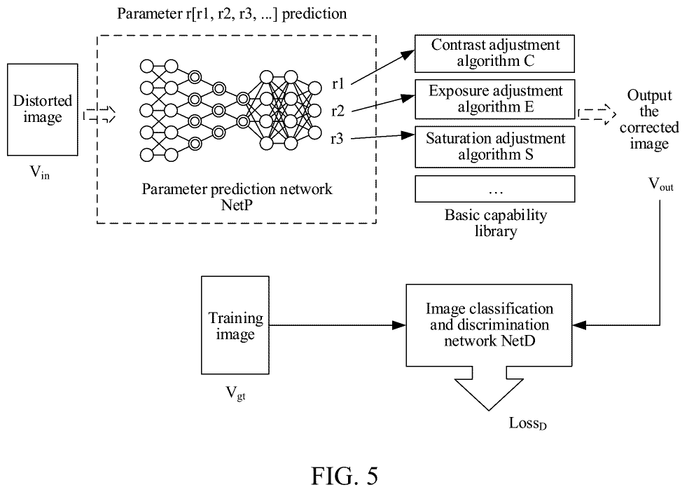

In some embodiments, FIG. 5 is a schematic diagram of a training framework of an image correction model. Specifically, the server obtains the distorted image Vᵢₙ as the input of the initial image correction model. In the initial image correction model, a parameter prediction network NetP is used to predict the image correction parameter to obtain the initial image correction parameter r[r1, r2, r3, . . . ], where r1 is the contrast adjustment parameter, r2 is the exposure adjustment parameter, and r3 is the saturation adjustment parameter. A network structure of the parameter prediction network NetP may be set according to the needs, or may be classic network structures such as visual geometry group (VGG), which is a deep convolutional network structure, Unet (a deep neural network structure composed of an encoder and a decoder), and MobileNet (a lightweight deep neural network). Then, image correction is performed on the distorted image based on the initial image correction parameter, that is, the contrast of the distorted image is adjusted through a contrast adjustment algorithm C in an image editing basic capability library based on the contrast adjustment parameter r1. The exposure of the distorted image is adjusted through an exposure adjustment algorithm E in an image editing basic capability library based on the exposure adjustment parameter r2. The saturation of the distorted image is adjusted through a saturation adjustment algorithm S in an image editing basic capability library based on the saturation adjustment parameter r3. The distorted image is corrected based on other image correction parameters. When the image correction is completed, the corrected image Vₒᵤₜ is outputted. Then, image classification and discrimination is performed through the image classification discriminator network NetD (abbreviated as D), that is, the corrected image Vₒᵤₜ is inputted into the image classification discriminator network NetD for image classification and discrimination, to obtain the classification and discrimination result of the corrected image, and the corresponding training image V_{gt} of the distorted image Vᵢₙ is inputted to the image classification discriminator network NetD for image classification and discrimination, to obtain the classification and discrimination result of the training image, and then the error between the classification and discrimination result of the corrected image and the classification and discrimination result of the training image is calculated. The discriminant loss information may be calculated by using formula (1). Then, the parameter loss information and the image loss information are calculated, and the parameter prediction network and the image classification discriminator network in the initial image correction model are updated based on the discriminant loss information, the parameter loss information and the image loss information, to obtain the updated image correction model. Besides, the updated image correction model is used as the initial image correction model and loop iteration is performed until when the training completion condition is reached, an image correction model obtained when the training completion condition is reached is used as the target image correction model obtained through training. In an embodiment, the initial image correction model may also be updated only based on the image loss information, to obtain an updated image correction model, which can improve the model training efficiency.

In an embodiment, operation 202 of obtaining the training image includes the following operations:
obtaining a target image, and inputting the target image into a target image segmentation model to perform image segmentation and identification, to obtain a mask image; performing mask area division based on the mask image to obtain each image area; and using each image area as the training image.

The target image refers to an image that needs to be segmented, and adjustment of different local areas of the target image requires different correction parameters. A mask image refers to a mask image obtained through image segmentation. Different local areas are identified in the mask image. For example, areas of different persons in the image are represented by different pixel values, and an area of the same person is represented by the same pixel value to obtain the mask image. The image area refers to an area in the target image. Different image areas may be different image contents, such as different objects, characters, and scenes. The target image segmentation model refers to a neural network model that segments images. The target image segmentation model is obtained by pre-training based on historical images and corresponding segmentation image labels. The segmentation image label may be a label of a segmented image area. The target image segmentation model may segment different objects in the image.

Specifically, the server obtains a target image, and inputs the target image into a target image segmentation model to perform image segmentation and identification, to obtain a mask image. Then, different mask areas are segmented based on the mask image to obtain each image area, and each image area is used as a training image. That is, by segmenting the target image and using each image area as a training image, the image correction model obtained through training may predict correction parameters corresponding to different image areas in the target image, thereby making the image correction more flexible and largely ensuring the uniqueness of local areas of the image.

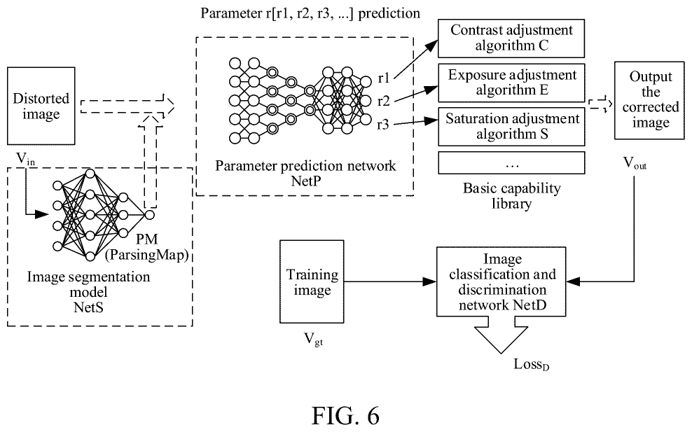

In some embodiments, FIG. 6 is a schematic diagram of a training framework of an image correction model. Specifically, the server may add the image segmentation model NetS based on the training framework shown in FIG. 5. That is, the server first inputs the distorted image into the image segmentation model for scene segmentation, identifies areas of persons, objects, animals, and the like in the image, to obtain the mask image PM, then segments different image areas according to the mask image to obtain each image area, then uses all image areas as training images in sequence, and inputs the training images into the training framework shown in FIG. 5 for subsequent training. When the training is completed, an image correction model that may predict the correction parameter of the local area of the image is obtained, then the image correction model that may predict the correction parameter of the local area of the image may be used to predict the correction parameter of the local area of the image, then the correction parameter of the local area is used to correct the local area of the image, and when all local areas of the image are corrected, the corrected image is obtained, which makes the image correction more flexible and improves the uniqueness of local areas of the image. Besides, some local areas of the image may be corrected to obtain corrected images of some local areas, further improving the flexibility of image correction.

In an embodiment, operation 202 of obtaining the training image includes the following operations:
obtaining a training video, and dividing the training video into frames to obtain each video frame; and using each video frame as the training image.

The training video refers to a video used when training the image correction model, and the training image may be obtained from the training video.

Specifically, the server may also obtain training videos from a database, or may obtain training videos uploaded by the terminal, or may obtain training videos from a service provider that provides data services. The training video is then divided into frames, where the frames may be divided according to a preset frame interval or a number of collected frames or a time to obtain each video frame. The server uses all video frames as training images in sequence to train the initial image correction model, so that the target image correction model obtained through training may accurately edit and correct the video image. In an embodiment, the server may extract key frames in the training video and use the key frames as training images.

In the above embodiment, each video frame is obtained by dividing the training video into frames, and each video frame is used as a training image to train the initial image correction model to obtain the target image correction model, so that the target image correction model may correct the video image, thereby expanding the application scenarios and improving the applicability.

In an embodiment, operation 202 of performing random data distortion based on the training image, to obtain a distorted image and distortion parameter information includes the following operations:
randomly generating the distortion parameter information; and adjusting the training image based on the distortion parameter information, to obtain the distorted image.

The distortion parameter information refers to parameters for adjusting the training image to obtain a distorted image, that is, the training image may be adjusted based on the distortion parameter information to produce an image that does not conform to the normal distribution, that is, a distorted image is obtained, or the training image may be adjusted based on the distortion parameter information to produce an image with distortion, and the image with distortion is used as a distorted image. Then, the corresponding correction parameter information may be determined based on the distortion parameter information.

Specifically, the server may randomly generate corresponding distortion parameter information, and may randomly generate parameters such as saturation, contrast, white balance, a color temperature, and exposure, and then correspondingly adjust the training image. For example, if a contrast parameter 0.2 is randomly generated, weighting calculation may be performed on the contrast of the training image based on the contrast parameter 0.2 to obtain the training image after contrast adjustment, that is, the distorted image. For another example, if an exposure parameter 0.2 is randomly generated, the exposure of the training image may be adjusted through an exposure adjustment algorithm based on the exposure parameter 0.2, to obtain the training image after exposure adjustment, that is, the distorted image is obtained. The exposure adjustment algorithm may be E(x, r1)=x*2.2^{r1}, E represents the training image after exposure adjustment, x represents the training image, and r1 represents the exposure parameter 0.2.

In the above embodiment, the distortion parameter information is randomly generated and the training image is adjusted, to obtain a distorted image, that is, the distorted image can be quickly obtained, thereby improving the efficiency of obtaining training data and saving the costs of obtaining data.

In an embodiment, operation 206 of calculating a loss between the initial correction parameter information and correction parameter information corresponding to the distortion parameter information, to obtain parameter loss information, and calculating a loss between the training image and the initial corrected image to obtain image loss information includes:
performing correction parameter calculation based on the distortion parameter information, to obtain correction parameter information; calculating an error between the correction parameter information and the initial correction parameter information, to obtain the parameter loss information; and calculating an error between the training image and the initial corrected image to obtain the image loss information.

The correction parameter information refers to parameter information for restoring the distorted image to a normal image. Based on the correction parameter information, an image that does not conform to normal distribution may be adjusted to an image with normal distribution, or a distorted image may be adjusted to a real normal image.

Specifically, the server may use the distortion parameter information to perform reverse adjustment to obtain the correction parameter information. For example, the correction parameter may be calculated based on contrast distortion parameter information to obtain contrast correction parameter information. The contrast distortion parameter is increased by 0.2 times, that is, weighting is performed on the contrast of the training image based on 0.2 to obtain the contrast distortion value. Then, the contrast distortion parameter is used to perform reverse adjustment, that is, the contrast value of the training image is decreased by 0.2 times, that is, it is obtained that the contrast correction parameter is decreased by 0.2 times. Then, the error between the correction parameter information and the initial correction parameter information is calculated based on a preset loss function, to obtain the parameter loss information, and the error between the training image and the initial corrected image is calculated based on a preset loss function, to obtain the image loss information.

In some embodiments, the parameter loss information may be calculated by using the following formula (2).

$$\\ \begin{matrix}Loss 1 = {‖ {r}_{pre} - {r}_{gt} ‖}_{p} . & formula ( 2 )\end{matrix}$$

Loss1 represents parameter loss information, and rₚᵣₑ represents correction parameter information and is obtained based on the distortion parameter. r_{gt} represents the initial correction parameter information, that is, the predicted correction parameter information. p may be set to 1 or 2. When p is 1, it indicates calculating an absolute value loss, and when p is 2, it indicates calculating a distance loss. The distance loss may be the Euclidean distance loss. The image loss information may also be calculated by using formula (3).

$$\\ \begin{matrix}Loss 2 = {‖ {V}_{out} - {V}_{gt} ‖}_{p} . & formula ( 3 )\end{matrix}$$

Loss2 represents image loss information, Vₒᵤₜ represents the corrected image, and V_{gt} represents the training image. p may be set to 1 or 2. When p is 1, it indicates calculating an absolute value loss, and when p is 2, it indicates calculating a distance loss. The distance loss may be the Euclidean distance loss. Finally, the model loss information is calculated by using the following formula (4).

$$\\ \begin{matrix}Loss = Loss 1 + Loss 2. & formula ( 4 )\end{matrix}$$

Loss represents the final calculated model loss information. The parameter of the to-be-trained initial image correction model is updated based on the model loss information and loop iteration is constantly performed. When the training completion condition is reached, the target image correction model is obtained.

In the above embodiment, the correction parameter is calculated based on the distortion parameter information, to obtain the correction parameter information, then the parameter loss information and the image loss information are calculated, and finally the model loss information is obtained, thereby ensuring the accuracy of the obtained correction parameter information and improving the accuracy of the obtained model loss information.

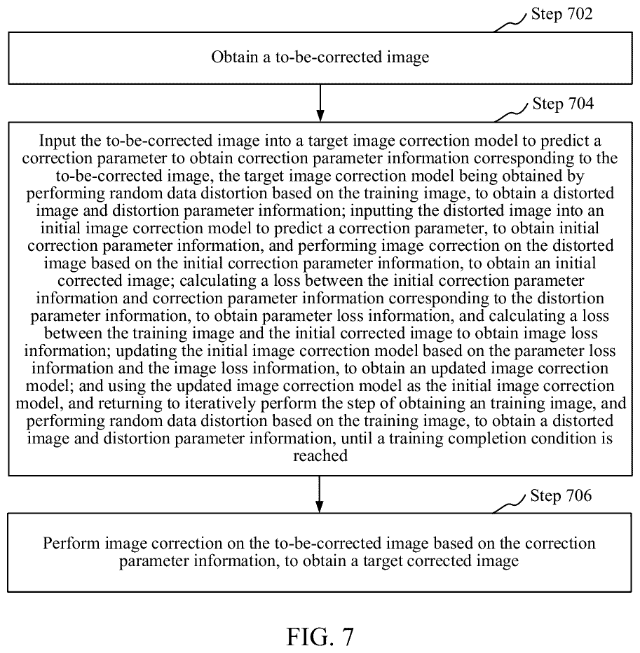

In an embodiment, as shown in FIG. 7, an image correction model training method is provided. The application of this method to the server in FIG. 1 is used as an example for illustration. This method may also be applied to a terminal, and may also be applied to a system including a terminal and a server, and is implemented through the interaction between a terminal and a server. In this embodiment, the method includes the following operations:

Operation 702: Obtain a to-be-corrected image.

The to-be-corrected image refers to an image that needs to be corrected, for example, may be an image with distortion, a distorted image, an image collected by an image acquisition apparatus, or an image with motion blur.

Specifically, the server may obtain the to-be-corrected image from the database, or may obtain the to-be-corrected image from a service provider, or may obtain an image collected by the terminal through an image acquisition apparatus. The image acquisition apparatus may be a camera.

Operation 706: Input the to-be-corrected image into a target image correction model to predict a correction parameter to obtain correction parameter information corresponding to the to-be-corrected image, the target image correction model being obtained by performing random data distortion based on the training image, to obtain a distorted image and distortion parameter information; inputting the distorted image into an initial image correction model to predict a correction parameter, to obtain initial correction parameter information, and performing image correction on the distorted image based on the initial correction parameter information, to obtain an initial corrected image; calculating a loss between the initial correction parameter information and correction parameter information corresponding to the distortion parameter information, to obtain parameter loss information, and calculating a loss between the training image and the initial corrected image to obtain image loss information; updating the initial image correction model based on the parameter loss information and the image loss information, to obtain an updated image correction model; and using the updated image correction model as the initial image correction model, and returning to iteratively perform the operation of obtaining a training image, and performing random data distortion based on the training image, to obtain a distorted image and distortion parameter information, until a training completion condition is reached.

The target image correction model is a deep neural network model for image correction. The target image correction model may be obtained through training based on any embodiment of the above image correction model training method. The correction parameter information corresponding to the to-be-corrected image refers to adjustment parameters used when correcting the to-be-corrected image, and may include adjustment parameters such as saturation, contrast, white balance, a color temperature, and exposure.

Specifically, the server establishes an image correction model in advance by using a deep neural network, performs training by using the image correction model training method to obtain the target image correction model, and then deploys the target image correction model.

When image correction is required, the server calls the deployed target image correction model, and inputs the to-be-corrected image into the target image correction model to predict the image correction parameter, to obtain the correction parameter information corresponding to the to-be-corrected image.

Operation 708: Perform image correction on the to-be-corrected image based on the correction parameter information, to obtain a target corrected image.

The target corrected image refers to an image obtained after correction. The image distribution of the target corrected image is normal, that is, the image is an image without distortion.

Specifically, the server determines, from the correction parameter information, the specific correction parameter to be used, and then uses the corresponding correction algorithm to correct the image based on the correction parameter. After the image is corrected based on all correction parameters, the target corrected image is obtained. In an embodiment, after the target corrected image is obtained, the image quality of the target corrected image may be enhanced through an image quality enhancement algorithm. The image quality enhancement algorithm may include artificial intelligence algorithms, such as neural network algorithms, may also include a histogram equalization algorithm and may be used for contrast enhancement of grayscale images, and may also include a grayscale world algorithm, Gamma transform, Laplace transform, a Retinex algorithm, and the like.

In the above image correction method, the to-be-corrected image is inputted into a target image correction model to predict a correction parameter to obtain correction parameter information corresponding to the to-be-corrected image, the target image correction model being obtained by performing random data distortion based on the training image, to obtain a distorted image and distortion parameter information; inputting the distorted image into an initial image correction model to predict a correction parameter, to obtain initial correction parameter information, and performing image correction on the distorted image based on the initial correction parameter information, to obtain an initial corrected image; calculating a loss based on the initial correction parameter information and the distortion parameter information, to obtain parameter loss information, and calculating a loss based on the training image and the initial corrected image to obtain image loss information; updating the initial image correction model based on the parameter loss information and the image loss information, to obtain an updated image correction model; and using the updated image correction model as the initial image correction model, and performing loop iteration, until a training completion condition is reached. Image correction is performed on the to-be-corrected image based on the correction parameter information, to obtain the target corrected image, thereby improving the accuracy of the obtained target corrected image, that is, improving the accuracy of the image correction. By performing image correction on the to-be-corrected image, the texture of the obtained target corrected image is improved, and the overall image looks more natural.

In an embodiment, operation 702 of obtaining a to-be-corrected image includes:
obtaining a to-be-corrected video, dividing the to-be-corrected video into frames to obtain each video frame, and using each video frame as a to-be-corrected image.

The to-be-corrected video refers to a video that needs to be corrected.

Specifically, the server may obtain the to-be-corrected video stored in a database, and the server may also obtain the to-be-corrected video collected by the terminal through an acquisition apparatus. The server may also obtain the to-be-corrected video from a service provider. The server then divides the to-be-corrected video into frames to obtain each video frame, and then corrects all video frames in sequence. That is, each video frame is used as a to-be-corrected image. In an embodiment, key video frames may be extracted as to-be-corrected images.

After operation 706 of performing image correction on the to-be-corrected image based on the correction parameter information, to obtain a target corrected image, the method further includes the following operation:
obtaining target corrected images corresponding to all the video frames, and combining the target corrected images corresponding to all the video frames, to obtain a target corrected video.

The target corrected video refers to a corrected video.

Specifically, the server combines, in sequence according to the order of all video frames, the target corrected images corresponding to all the video frames, to obtain the target corrected video, where target corrected images may be combined in sequence according to the timeline of the to-be-corrected video, to obtain the target corrected video.

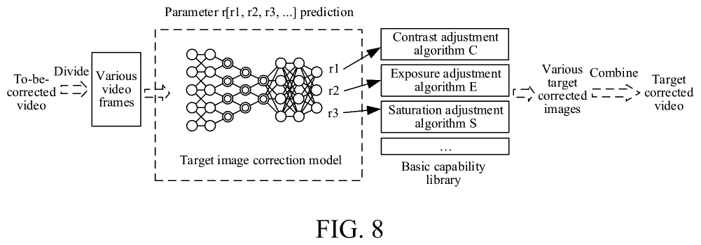

In some embodiments, FIG. 8 is a schematic diagram of correcting a video. Specifically, the server obtains the to-be-corrected video, divides the to-be-corrected video into various video frames, and then inputs the video frames into the target image correction model in sequence to predict correction parameters, to obtain outputted correction parameter information, which may include a contrast correction parameter, an exposure correction parameter, a saturation correction parameter, and the like. Then, a corresponding correction algorithm is called from the basic capability library to perform image correction. The contrast of the video frame may be adjusted through the contrast adjustment algorithm C based on the contrast correction parameter, the exposure of the video frame may be adjusted through the exposure adjustment algorithm E based on the exposure correction parameter, the saturation of the video frame may be adjusted through the saturation adjustment algorithm S based on the saturation correction parameter, and the image may also be corrected through other responsive correction algorithms. Finally, various target corrected images are obtained, and then the target corrected images are combined to obtain the target corrected video.

In the above embodiment, video frames are obtained by dividing the to-be-corrected video into frames, then image correction is performed on the video frames to obtain target corrected images, and the target corrected images corresponding to the video frames are combined to obtain the target corrected video, thereby improving the accuracy of video correction.

In an embodiment, operation 702 of obtaining a to-be-corrected image includes:
obtaining a target to-be-corrected image, and inputting the target to-be-corrected image into a target image segmentation model to perform image segmentation and identification, to obtain a mask image; performing mask area division based on the mask image to obtain each image area; and using each image area as the to-be-corrected image.

The target to-be-corrected image refers to an image that requires different corrections for different local areas. For example, a person scene image requires different corrections for a person area and a background area in the image. The mask image refers to a mask image obtained after image segmentation and identification of the target to-be-corrected image. For example, in the mask image corresponding to the person scene image, the pixels in the person area are 1 and the pixels in the background area are 0. The target image segmentation model is configured for segmenting and identifying the input image and may segment and identify the person in the image, and may also segment and identify the object in the image.

Specifically, the server may obtain the target to-be-corrected image from a database or a service provider, and may also obtain the target to-be-corrected image uploaded by the terminal. Then, the server inputs the target to-be-corrected image into the target image segmentation model for image segmentation and identification to obtain a mask image, and then divides the target to-be-corrected image according to the mask image to obtain each image area, where the image area is a local area in the to-be-corrected image.

After operation 706 of performing image correction on the to-be-corrected image based on the correction parameter information, to obtain a target corrected image, the method further includes the following operation:
obtaining target corrected images corresponding to all image areas, and fusing, according to the mask image, the target corrected images corresponding to all the image areas, to obtain a fusion corrected image.

The fusion corrected image refers to an image obtained after image correction of different image areas.

Specifically, the server fuses, according to the area division of the mask image, the target corrected images corresponding to the image areas, and replaces each local image area in the target to-be-corrected image with the target corrected image, to obtain the fusion corrected image. In an embodiment, a target image area may also be selected as the to-be-corrected image from the image areas according to a preset rule, and image correction is not performed on other image areas. For example, image correction may be performed only on the person image area and other image areas remain the same, and then the person image area is replaced with the corrected image, and other image areas remain unchanged to obtain the corrected person image.

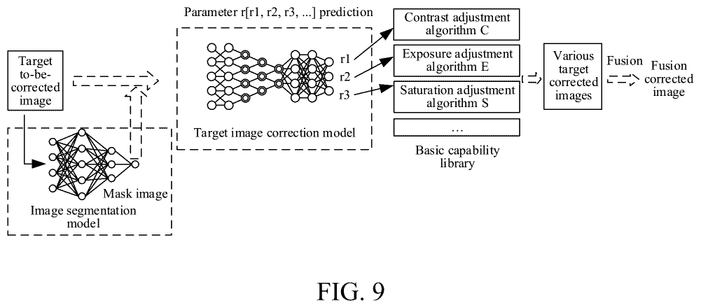

In some embodiments, FIG. 9 is a schematic diagram of obtaining the fusion corrected image. Specifically, the server obtains the target to-be-corrected image, inputs the target to-be-corrected image into the target image segmentation model for image segmentation and identification, to obtain the mask image, divides the area of the target to-be-corrected image according to the mask image, to obtain image areas, and then inputs the image areas into the target image correction model in sequence for correction parameter prediction, to obtain the outputted correction parameter information, which may include a contrast correction parameter, an exposure correction parameter, a saturation correction parameter, and the like. Then, a corresponding correction algorithm is called from the basic capability library to perform image correction. The contrast of the image area may be adjusted through the contrast adjustment algorithm C based on the contrast correction parameter, the exposure of the image area may be adjusted through the exposure adjustment algorithm E based on the exposure correction parameter, the saturation of the image area may be adjusted through the saturation adjustment algorithm S based on the saturation correction parameter, and the image area may also be corrected through other responsive correction algorithms. Target corrected images corresponding to all image areas are obtained finally, and the target corrected images corresponding to all the image areas are fused according to the mask image, to obtain a fusion corrected image.

In the above embodiment, image identification and segmentation are performed in the target image segmentation model to obtain the image areas, and then the target image correction model is used to perform image correction on the image areas to obtain the corresponding target corrected images. Finally, the target corrected images corresponding to the image areas are fused according to the mask image to obtain a fusion corrected image, which can improve the flexibility of image correction.

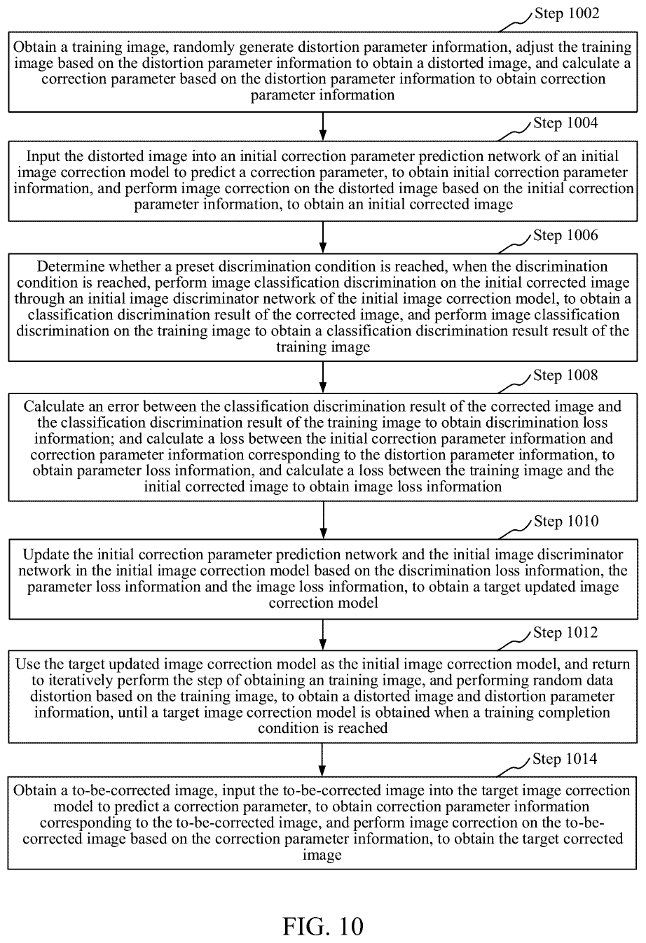

In some embodiments, FIG. 10 shows an image correction method. The method specifically includes the following operations:

Operation 1002: Obtain a training image, randomly generate distortion parameter information, adjust the training image based on the distortion parameter information to obtain a distorted image, and calculate a correction parameter based on the distortion parameter information to obtain correction parameter information.

Operation 1004: Input the distorted image into an initial correction parameter prediction network of an initial image correction model to predict a correction parameter, to obtain initial correction parameter information, and perform image correction on the distorted image based on the initial correction parameter information, to obtain an initial corrected image.

Operation 1006: Determine whether a preset discrimination condition is reached, when the discrimination condition is reached, perform image classification and discrimination on the initial corrected image through an initial image discriminator network of the initial image correction model, to obtain a classification and discrimination result of the corrected image, and perform image classification and discrimination on the training image to obtain a classification and discrimination result of the training image.

Operation 1008: Calculate an error between the classification and discrimination result of the corrected image and the classification and discrimination result of the training image to obtain discriminant loss information; and calculate a loss between the initial correction parameter information and correction parameter information corresponding to the distortion parameter information, to obtain parameter loss information, and calculate a loss between the training image and the initial corrected image to obtain image loss information.

Operation 1010: Update the initial correction parameter prediction network and the initial image discriminator network in the initial image correction model based on the discriminant loss information, the parameter loss information and the image loss information, to obtain a target updated image correction model, and when the discrimination condition is not reached, update the initial correction parameter prediction network of the initial image correction model based on the parameter loss information and the image loss information, until the preset discrimination condition is reached.

Operation 1012: Use the target updated image correction model as the initial image correction model, and return to iteratively perform the operation of obtaining a training image, and performing random data distortion based on the training image, to obtain a distorted image and distortion parameter information, until a target image correction model is obtained when a training completion condition is reached.

Operation 1014: Obtain a to-be-corrected image, input the to-be-corrected image into the target image correction model to predict a correction parameter, to obtain correction parameter information corresponding to the to-be-corrected image, and perform image correction on the to-be-corrected image based on the correction parameter information, to obtain the target corrected image.

In some embodiments, this is applied to an image sharing platform. Specifically: a user logs in to the image sharing platform through a terminal. When image sharing is required, the image sharing platform activates a camera apparatus in the terminal to collect images. The collected image is an image that needs to be corrected. In this case, the image sharing platform inputs the collected image into the target image correction model to obtain the target correction parameter information, and performs image correction on the collected image through the target correction parameter information, that is, adjusts the saturation, contrast, white balance, color temperature, exposure, and the like of the collected image, to obtain an adjusted image, that is, a corrected image. The corrected image is then displayed to the user through the terminal, which can save the adjustment time and energy of the user and increase user stickiness. In this case, the user can further perform image enhancement on the corrected image, to obtain a final to-be-shared image. In this case, when receiving an operation instruction for sharing the final to-be-shared image through the terminal, the image sharing platform sends the to-be-shared image to each image sharing display page for display. Friends of the user may view the image through the image sharing display page of the image sharing platform, which can improve the effect of sharing the image and avoid distortion, blur, distortion and other problems.

In some embodiments, this is applied to a video sharing platform. Specifically: a user logs in to the video sharing platform through a terminal. When video sharing is required, the video sharing platform activates a camera apparatus in the terminal to collect videos. The collected video is a video that needs to be corrected. In this case, the video sharing platform divides the collected video into frames to obtain video frames, then extracts key video frames from the video frames, inputs the key video frames into the target image correction model in sequence to obtain target correction parameter information corresponding to each key video frame, performs image correction on the collected key video frames based on the target correction parameter information, that is, adjusts the saturation, contrast, white balance, color temperature, exposure, and the like of the key video frames to obtain adjusted key video frames, and then corrects a video frame between the key video frames based on the target correction parameter information corresponding to each key video frame, for example, corrects a video frame within a preset range of each key video frame. Finally, all video frames are corrected to obtain the target corrected image corresponding to each video frame, and then the target corrected images corresponding to all the video frames are combined to obtain the corrected video. The corrected video is then displayed to the user through the terminal, which can save the adjustment time and energy of the user and increase user stickiness. In this case, when receiving an operation instruction for sharing the final to-be-shared corrected video through the terminal, the video sharing platform sends the to-be-shared corrected video to each video sharing page for display. Friends of the user can view the corrected video through the video sharing page of the video sharing platform.

Although the operations are displayed sequentially according to the instructions of the arrows in the flowcharts of the embodiments, these operations are not necessarily performed sequentially according to the sequence instructed by the arrows. Unless otherwise explicitly specified in this application, execution of the operations is not strictly limited, and the operations may be performed in other sequences. Moreover, at least some of the operations in flowcharts in each embodiment may include multiple sub-operations or multiple stages. The operations or stages are not necessarily performed at the same moment but may be performed at different moments. Execution of the operations or stages is not necessarily sequentially performed, but may be performed alternately with other operations or at least some operations or stages of other operations.

Based on the same inventive concept, the embodiments of this application further provide an image correction model training apparatus for implementing the above image correction model training method or an image correction apparatus for implementing the above image correction method. The implementation solution to the problem provided by the apparatus is similar to the implementation solution described in the above method. Therefore, for specific definitions in one or more embodiments of the image correction model training apparatus or embodiments of the image correction apparatus provided below, refer to the above definitions in the image correction model training method or the image correction method. Details are not repeated herein.

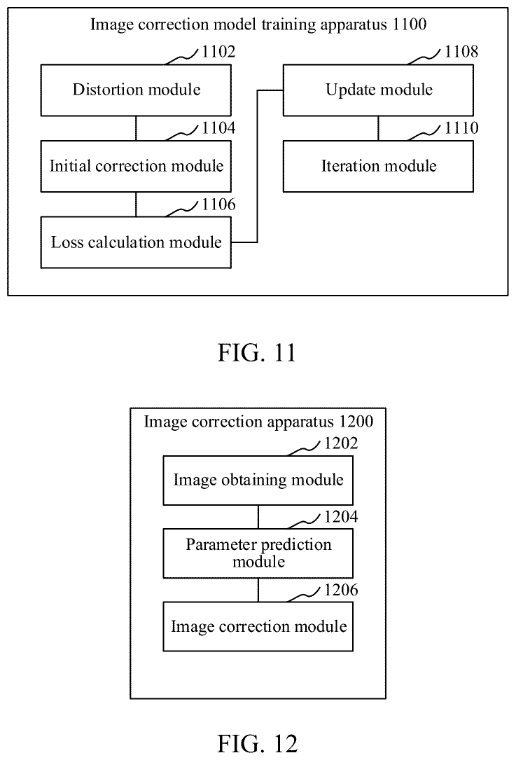

In an embodiment, as shown in FIG. 11, an image correction model training apparatus 1100 is provided, including: a distortion module 1102, an initial correction module 1104, a loss calculation module 1106, an update module 1108, and an iteration module 1110.

The distortion module 1102 is configured to obtain a training image, and perform random data distortion based on the training image, to obtain a distorted image and distortion parameter information.

The initial correction module 1104 is configured to input the distorted image into an initial image correction model to predict a correction parameter, to obtain initial correction parameter information, and perform image correction on the distorted image based on the initial correction parameter information, to obtain an initial corrected image.

The loss calculation module 1106 is configured to calculate a loss between the initial correction parameter information and correction parameter information corresponding to the distortion parameter information, to obtain parameter loss information, and calculate a loss between the training image and the initial corrected image to obtain image loss information.

The update module 1108 is configured to update the initial image correction model based on the parameter loss information and the image loss information, to obtain an updated image correction model.

The iteration module 1110 is configured to use the updated image correction model as the initial image correction model, and return to iteratively perform the operation of obtaining a training image, and performing random data distortion based on the training image, to obtain a distorted image and distortion parameter information, until a target image correction model is obtained when a training completion condition is reached, the target image correction model being configured for predicting a correction parameter of an inputted image to obtain target correction parameter information, and the target correction parameter information being configured for performing image correction on the inputted image to obtain a target corrected image.

In an embodiment, the image correction model training apparatus 1100 further includes:
a discrimination module, configured to perform image classification and discrimination on the initial corrected image through the initial image correction model, to obtain a classification and discrimination result of the corrected image; perform image classification and discrimination on the training image through the initial image correction model, to obtain a classification and discrimination result of the training image; and calculate an error between the classification and discrimination result of the corrected image and the classification and discrimination result of the training image to obtain discriminant loss information.

The update module 1108 is further configured to update the initial image correction model based on the discriminant loss information, the parameter loss information and the image loss information, to obtain a target updated image correction model.

In an embodiment, the discrimination module is further configured to obtain current model loss information corresponding to the initial image correction model; and when the current model loss information meets a discriminant training condition, perform image classification and discrimination on the initial corrected image through the initial image correction model, to obtain the classification and discrimination result of the corrected image.

In an embodiment, the initial image correction model includes an initial correction parameter prediction network; and
the initial correction module 1104 is further configured to input the distorted image into an initial correction parameter prediction network to predict the correction parameter, to obtain initial correction parameter information; and perform weighting on the distorted image based on the initial correction parameter information, to obtain the initial corrected image.

In an embodiment, the initial image correction model further includes an initial image discriminator network; and
the image correction model training apparatus 1100 further includes:
a network discrimination module, configured to input the initial corrected image into the initial image discriminator network for image classification and discrimination, to obtain a classification and discrimination result of the corrected image; and input the training image into the initial image discriminator network for image classification and discrimination, to obtain a classification and discrimination result of the training image.

The update module 1108 is further configured to calculate an error between the classification and discrimination result of the corrected image and the classification and discrimination result of the training image to obtain discriminant loss information; and update the initial correction parameter prediction network and the initial image discriminator network in the initial image correction model based on the discriminant loss information, the parameter loss information and the image loss information, to obtain a target updated image correction model.

In an embodiment, the image correction model training apparatus 1100 further includes:
a pre-training module, configured to obtain a pre-training image and an image classification and discrimination label; input the pre-training image into a to-be-trained image discriminator network for image discrimination, to obtain a classification and discrimination result of the pre-training image; calculate a loss between the classification and discrimination result of the pre-training image and the image classification and discrimination label, to obtain pre-training loss information; and update the to-be-trained image discriminator network based on the pre-training loss information, to obtain an updated image discriminator network, use the updated image discriminator network as the to-be-trained image discriminator network, and return to iteratively perform the operation of obtaining a pre-training image and an image classification and discrimination label, until the initial image discriminator network is obtained when a pre-training completion condition is reached.

In an embodiment, the distortion module 1102 is further configured to obtain a target image, and input the target image into a target image segmentation model to perform image segmentation and identification, to obtain a mask image; perform mask area division based on the mask image to obtain each image area; and use each image area as the training image.

In an embodiment, the distortion module 1102 is further configured to obtain a training video, and divide the training video into frames to obtain each video frame; and use each video frame as the training image.

In an embodiment, the distortion module 1102 is further configured to randomly generate the distortion parameter information; and adjust the training image based on the distortion parameter information, to obtain the distorted image.

In an embodiment, the update module 1108 is further configured to perform correction parameter calculation based on the distortion parameter information, to obtain correction parameter information;
calculate an error between the correction parameter information and the initial correction parameter information, to obtain the parameter loss information; and
calculate an error between the training image and the initial corrected image to obtain the image loss information.

In an embodiment, as shown in FIG. 12, an image correction apparatus 1200 is provided, including: an image obtaining module 1202, a parameter prediction module 1204, and an image correction module 1206.

The image obtaining module 1202 is configured to obtain a to-be-corrected image.

The parameter prediction module 1204 is configured to input the to-be-corrected image into a target image correction model to predict a correction parameter to obtain correction parameter information corresponding to the to-be-corrected image, the target image correction model being obtained by performing random data distortion based on the training image, to obtain a distorted image and distortion parameter information; inputting the distorted image into an initial image correction model to predict a correction parameter, to obtain initial correction parameter information, and performing image correction on the distorted image based on the initial correction parameter information, to obtain an initial corrected image; calculating a loss between the initial correction parameter information and correction parameter information corresponding to the distortion parameter information, to obtain parameter loss information, and calculating a loss between the training image and the initial corrected image to obtain image loss information; updating the initial image correction model based on the parameter loss information and the image loss information, to obtain an updated image correction model; and using the updated image correction model as the initial image correction model, and returning to iteratively perform the operation of obtaining a training image, and performing random data distortion based on the training image, to obtain a distorted image and distortion parameter information, until a training completion condition is reached.

The image correction module 1206 is configured to perform image correction on the to-be-corrected image based on the correction parameter information, to obtain a target corrected image.

In an embodiment, the image obtaining module 1202 is further configured to obtain a to-be-corrected video, and divide the to-be-corrected video into frames to obtain each video frame; and use each video frame as the to-be-corrected image.

The image correction apparatus 1200 further includes:
an image combination module, configured to obtain target corrected images corresponding to all the video frames, and combine the target corrected images corresponding to all the video frames, to obtain a target corrected video.

In an embodiment, the image obtaining module 1202 is further configured to obtain a target to-be-corrected image, and input the target to-be-corrected image into a target image segmentation model to perform image segmentation and identification, to obtain a mask image; perform mask area division based on the mask image to obtain each image area; and use each image area as the to-be-corrected image.

The image correction apparatus 1200 further includes:
an image fusion module, configured to obtain target corrected images corresponding to all image areas, and fuse, according to the mask image, the target corrected images corresponding to all the image areas, to obtain a fusion corrected image.

The various modules in the above image correction model training apparatus or the image correction apparatus can be fully or partially implemented through software, hardware, and their combinations. The above modules can be embedded in the processor in the computer device in the form of hardware or independent of the processor in the computer device, and can also be stored in the memory of the computer device in the form of software, so that the processor can invoke and execute the corresponding operations of the above modules.

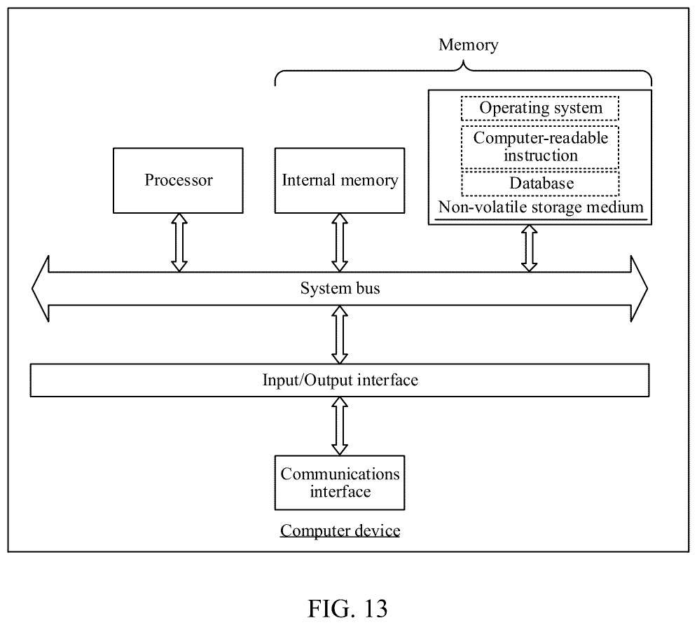

In an embodiment, a computer device is provided and can be a server. An internal structure thereof can be shown in FIG. 13. The computer device includes a processor, a memory, an input/output interface (I/O for short), and a communications interface. The processor, the memory, and the input/output interface are connected through a system bus, and the communications interface is connected to the system bus through the input/output interface. The processor of the computer device is configured to provide computation and control ability. The memory of the computer device includes a non-volatile storage medium and an inner memory. The non-volatile storage medium stores an operating system, computer-readable instructions, and databases. The inner memory provides an operating environment for the operating system and the computer-readable instructions in the non-volatile storage medium. The database of the computer device is configured to store training image data, to-be-corrected images, to-be-corrected videos, and the like. The input/output interface of the computer device is configured to exchange information between the processor and external devices. The communications interface of the computer device is configured to communicate with an external terminal by using a network connection. The computer-readable instruction is executed by the processor to implement an image correction model training method or an image correction method.

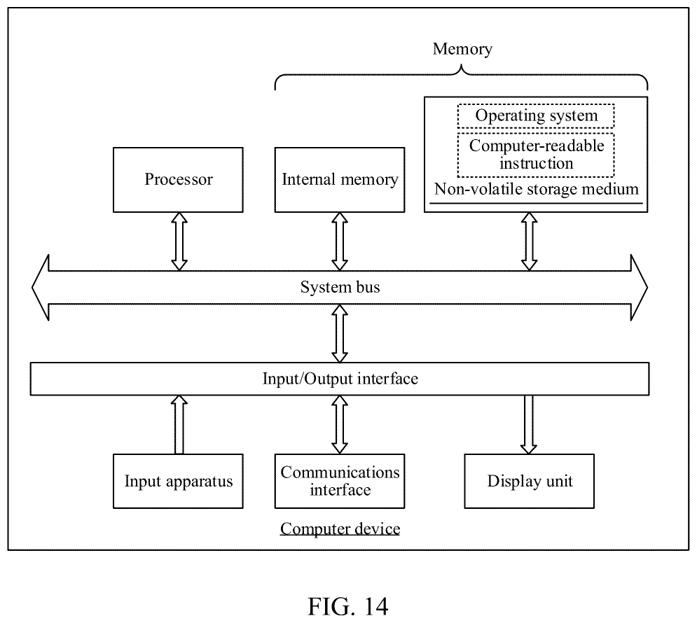

In an embodiment, a computer device is provided and may be a terminal. An internal structure thereof may be shown in FIG. 14. The computer device includes a processor, a memory, an input/output interface, a communications interface, a display unit and an input apparatus. The processor, the memory, and the input/output interface are connected through a system bus, and the communications interface, the display unit, and the input apparatus are connected to the system bus through the input/output interface. The processor of the computer device is configured to provide computation and control ability. The memory of the computer device includes a non-volatile storage medium and an inner memory. The non-volatile storage medium stores an operating system and computer-readable instructions. The inner memory provides an operating environment for the operating system and the computer-readable instructions in the non-volatile storage medium. The input/output interface of the computer device is configured to exchange information between the processor and external devices. The communications interface of the computer device is used for communication in a wired or wireless mode with external terminals. The wireless mode may be implemented through WIFI, mobile cellular networks, near field communication (NFC) or other technologies. The computer-readable instruction is executed by the processor to implement an image correction model training method or an image correction method. The display unit of the computer device is configured to form visual images, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, a mouse or the like.

A person skilled in the art may understand that the structure shown in FIG. 13 or FIG. 14 is only a block diagram of a partial structure related to the solution of this application, and does not limit the computer device to which the solution of this application is applied. Specifically, the computer device may include more or less components than those shown in the figure, or some components may be combined, or different component deployment may be used.

In an embodiment, a computer device is further provided, including: a memory and a processor, the memory stores computer-readable instructions, and the computer-readable instructions, when executed by the processor, performs the operations of the foregoing method embodiments.

In an embodiment, a computer-readable storage medium is provided, and stores computer-readable instructions. The computer-readable instructions, when executed by the processor, perform the operations of the foregoing method embodiments.

In an embodiment, a computer program product is provided, and stores computer-readable instructions. The computer-readable instructions, when executed by the processor, perform the operations of the foregoing method embodiments.

The user information (including but not limited to user equipment information, user personal information, or the like) and data (including but not limited to data used for analysis, stored data, displayed data, or the like) involved in this application are information and data that are authorized by the user or that have been fully authorized by all parties, and the collection, use and processing of relevant data need to comply with relevant laws, regulations and standards of relevant countries and regions.

A person of ordinary skill in the art may understand that all or some of procedures of the method in the foregoing embodiments may be implemented by a computer-readable instruction instructing relevant hardware. The computer-readable instruction may be stored in a non-volatile computer-readable storage medium. When the computer-readable instruction is executed, the procedures of the foregoing method embodiments may be implemented. References to the memory, the database, or other medium used in the embodiments provided in this application may all include a non-volatile or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may be a random access memory (RAM) or an external cache. As an illustration and not a limitation, the RAM may be in various forms, such as a static random access memory (SRAM) or a dynamic random access memory (DRAM). The database involved in the various embodiments provided in this application may include at least one of a relational database and a non-relational database. The non-relational database may include a blockchain-based distributed database or the like, but is not limited thereto. The processors involved in the various embodiments provided by this application may be general-purpose processors, central processing units, graphics processors, digital signal processors, programmable logic devices, data processing logic devices based on quantum computing, and are not limited thereto.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments show only several implementations of this application and are described in detail, which, however, are not to be construed as a limitation to the patent scope of this application. For a person of ordinary skill in the art, several transformations and improvements can be made without departing from the idea of this application. These transformations and improvements belong to the protection scope of this application. Therefore, the protection scope of this application shall be subject to the appended claims.

What is claimed is:

1. An image correction model training method, the method comprising:
obtaining a training image, and performing random data distortion based on the training image, to obtain a distorted image and distortion parameter information;
inputting the distorted image into an initial image correction model to predict a correction parameter, to obtain initial correction parameter information, and performing image correction on the distorted image based on the initial correction parameter information, to obtain an initial corrected image;
calculating a loss between the initial correction parameter information and correction parameter information corresponding to the distortion parameter information, to obtain parameter loss information, and calculating a loss between the training image and the initial corrected image to obtain image loss information;
updating the initial image correction model based on the parameter loss information and the image loss information, to obtain an updated image correction model; and
using the updated image correction model as the initial image correction model, and performing training and obtaining the updated image correction model iteratively, until a target image correction model is obtained when a training completion condition is reached, the target image correction model being configured for performing image correction on the inputted image to obtain a target corrected image.

2. The method according to claim 1, after the inputting the distorted image into an initial image correction model to predict a correction parameter, to obtain initial correction parameter information, and performing image correction on the distorted image based on the initial correction parameter information, to obtain an initial corrected image, further comprising:
performing image classification and discrimination on the initial corrected image through the initial image correction model, to obtain a classification and discrimination result of the corrected image;
performing image classification and discrimination on the training image through the initial image correction model, to obtain a classification and discrimination result of the training image; and
calculating an error between the classification and discrimination result of the corrected image and the classification and discrimination result of the training image to obtain discriminant loss information; and
the updating the initial image correction model based on the parameter loss information and the image loss information, to obtain an updated image correction model comprises:
updating the initial image correction model based on the discriminant loss information, the parameter loss information and the image loss information, to obtain a target updated image correction model.

3. The method according to claim 2, wherein the performing image classification and discrimination on the initial corrected image through the initial image correction model, to obtain a classification and discrimination result of the corrected image comprises:
obtaining current model loss information corresponding to the initial image correction model; and
when the current model loss information meets a discriminant training condition, performing image classification and discrimination on the initial corrected image through the initial image correction model, to obtain the classification and discrimination result of the corrected image.

4. The method according to any claim 1, wherein the initial image correction model comprises an initial correction parameter prediction network; and
the inputting the distorted image into an initial image correction model to predict a correction parameter, to obtain initial correction parameter information, and performing image correction on the distorted image based on the initial correction parameter information, to obtain an initial corrected image comprises:
inputting the distorted image into an initial correction parameter prediction network to predict the correction parameter, to obtain initial correction parameter information; and
performing weighting on the distorted image based on the initial correction parameter information, to obtain the initial corrected image.

5. The method according to claim 4, wherein the initial image correction model further comprises an initial image discriminator network; and
after the performing weighting on the distorted image based on the initial correction parameter information, to obtain the initial corrected image, further comprising:
inputting the initial corrected image into the initial image discriminator network for image classification and discrimination, to obtain a classification and discrimination result of the corrected image; and
inputting the training image into the initial image discriminator network for image classification and discrimination, to obtain a classification and discrimination result of the training image; and
the updating the initial image correction model based on the parameter loss information and the image loss information, to obtain an updated image correction model comprises:
calculating an error between the classification and discrimination result of the corrected image and the classification and discrimination result of the training image to obtain discriminant loss information; and
updating the initial correction parameter prediction network and the initial image discriminator network in the initial image correction model based on the discriminant loss information, the parameter loss information and the image loss information, to obtain a target updated image correction model.

6. The method according to claim 5, wherein pre-training of the initial image discriminator network comprises the following operations:
obtaining a pre-training image and an image classification and discrimination label;
inputting the pre-training image into a to-be-trained image discriminator network for image discrimination, to obtain a classification and discrimination result of the pre-training image;
calculating a loss between the classification and discrimination result of the pre-training image and the image classification and discrimination label, to obtain pre-training loss information; and
updating the to-be-trained image discriminator network based on the pre-training loss information, to obtain an updated image discriminator network, using the updated image discriminator network as the to-be-trained image discriminator network, and returning to iteratively perform the operation of obtaining a pre-training image and an image classification and discrimination label, until the initial image discriminator network is obtained when a pre-training completion condition is reached.

7. The method according to claim 1, wherein the obtaining a training image comprises:
obtaining a target image, and inputting the target image into a target image segmentation model to perform image segmentation and identification, to obtain a mask image;
performing mask area division based on the mask image to obtain each image area; and
using each image area as the training image.

8. The method according to claim 1, wherein the obtaining a training image comprises:
obtaining a training video, and dividing the training video into frames to obtain each video frame; and
using each video frame as the training image.

9. The method according claim 1, wherein the performing random data distortion based on the training image, to obtain a distorted image and distortion parameter information comprises:
randomly generating the distortion parameter information; and
adjusting the training image based on the distortion parameter information, to obtain the distorted image.

10. The method according to claim 1, wherein the calculating a loss between the initial correction parameter information and correction parameter information corresponding to the distortion parameter information, to obtain parameter loss information, and calculating a loss between the training image and the initial corrected image to obtain image loss information comprises:
performing correction parameter calculation based on the distortion parameter information, to obtain correction parameter information;
calculating an error between the correction parameter information and the initial correction parameter information, to obtain the parameter loss information; and
calculating an error between the training image and the initial corrected image to obtain the image loss information.

11. An image correction method, the method comprising:
obtaining a to-be-corrected image;
inputting the to-be-corrected image into a target image correction model to predict a correction parameter to obtain correction parameter information corresponding to the to-be-corrected image, the target image correction model being obtained by:
performing random data distortion based on a training image, to obtain a distorted image and distortion parameter information; inputting the distorted image into an initial image correction model to predict a correction parameter, to obtain initial correction parameter information, and performing image correction on the distorted image based on the initial correction parameter information, to obtain an initial corrected image; calculating a loss between the initial correction parameter information and correction parameter information corresponding to the distortion parameter information, to obtain parameter loss information, and calculating a loss between the training image and the initial corrected image to obtain image loss information; updating the initial image correction model based on the parameter loss information and the image loss information, to obtain an updated image correction model; and using the updated image correction model as the initial image correction model, and repeating above training steps iteratively to obtain a distorted image and distortion parameter information, until a training completion condition is satisfied; and
performing image correction on the to-be-corrected image based on the correction parameter information, to obtain a target corrected image.

12. The method according to claim 11, wherein the obtaining a to-be-corrected image comprises:
obtaining a to-be-corrected video, and dividing the to-be-corrected video into frames to obtain each video frame; and
using each video frame as the to-be-corrected image; and
after the performing image correction on the to-be-corrected image based on the correction parameter information, to obtain a target corrected image, the method further comprises:
obtaining target corrected images corresponding to all the video frames, and combining the target corrected images corresponding to all the video frames, to obtain a target corrected video.

13. The method according to claim 11, wherein the obtaining a to-be-corrected image comprises:
obtaining a target to-be-corrected image, and inputting the target to-be-corrected image into a target image segmentation model to perform image segmentation and identification, to obtain a mask image;
performing mask area division based on the mask image to obtain each image area; and
using each image area as the to-be-corrected image; and
after the performing image correction on the to-be-corrected image based on the correction parameter information, to obtain a target corrected image, the method further comprises:
obtaining target corrected images corresponding to all image areas, and fusing, according to the mask image, the target corrected images corresponding to all the image areas, to obtain a fusion corrected image.

14. A computer device, comprising a memory and a processor, the memory storing computer-readable instructions; and when the processor executes the computer-readable instructions, operations of a training method comprising:
obtaining a training image, and performing random data distortion based on the training image, to obtain a distorted image and distortion parameter information;
inputting the distorted image into an initial image correction model to predict a correction parameter, to obtain initial correction parameter information, and performing image correction on the distorted image based on the initial correction parameter information, to obtain an initial corrected image;
calculating a loss between the initial correction parameter information and correction parameter information corresponding to the distortion parameter information, to obtain parameter loss information, and calculating a loss between the training image and the initial corrected image to obtain image loss information;
updating the initial image correction model based on the parameter loss information and the image loss information, to obtain an updated image correction model; and
using the updated image correction model as the initial image correction model, and performing training and obtaining the updated image correction model iteratively, until a target image correction model is obtained when a training completion condition is reached, the target image correction model being configured for performing image correction on the inputted image to obtain a target corrected image.

15. The computer device according to claim 14, after the inputting the distorted image into an initial image correction model to predict a correction parameter, to obtain initial correction parameter information, and performing image correction on the distorted image based on the initial correction parameter information, to obtain an initial corrected image, further comprising:
performing image classification and discrimination on the initial corrected image through the initial image correction model, to obtain a classification and discrimination result of the corrected image;
performing image classification and discrimination on the training image through the initial image correction model, to obtain a classification and discrimination result of the training image; and
calculating an error between the classification and discrimination result of the corrected image and the classification and discrimination result of the training image to obtain discriminant loss information; and
the updating the initial image correction model based on the parameter loss information and the image loss information, to obtain an updated image correction model comprises:
updating the initial image correction model based on the discriminant loss information, the parameter loss information and the image loss information, to obtain a target updated image correction model.

16. The computer device according to claim 15, wherein the performing image classification and discrimination on the initial corrected image through the initial image correction model, to obtain a classification and discrimination result of the corrected image comprises:
obtaining current model loss information corresponding to the initial image correction model; and
when the current model loss information meets a discriminant training condition, performing image classification and discrimination on the initial corrected image through the initial image correction model, to obtain the classification and discrimination result of the corrected image.

17. The computer device according to any claim 14, wherein the initial image correction model comprises an initial correction parameter prediction network; and
the inputting the distorted image into an initial image correction model to predict a correction parameter, to obtain initial correction parameter information, and performing image correction on the distorted image based on the initial correction parameter information, to obtain an initial corrected image comprises:
inputting the distorted image into an initial correction parameter prediction network to predict the correction parameter, to obtain initial correction parameter information; and
performing weighting on the distorted image based on the initial correction parameter information, to obtain the initial corrected image.

18. The computer device according to claim 17, wherein the initial image correction model further comprises an initial image discriminator network; and
after the performing weighting on the distorted image based on the initial correction parameter information, to obtain the initial corrected image, further comprising:
inputting the initial corrected image into the initial image discriminator network for image classification and discrimination, to obtain a classification and discrimination result of the corrected image; and
inputting the training image into the initial image discriminator network for image classification and discrimination, to obtain a classification and discrimination result of the training image; and
the updating the initial image correction model based on the parameter loss information and the image loss information, to obtain an updated image correction model comprises:
calculating an error between the classification and discrimination result of the corrected image and the classification and discrimination result of the training image to obtain discriminant loss information; and
updating the initial correction parameter prediction network and the initial image discriminator network in the initial image correction model based on the discriminant loss information, the parameter loss information and the image loss information, to obtain a target updated image correction model.

19. The computer device according to claim 18, wherein pre-training of the initial image discriminator network comprises the following operations:
obtaining a pre-training image and an image classification and discrimination label;
inputting the pre-training image into a to-be-trained image discriminator network for image discrimination, to obtain a classification and discrimination result of the pre-training image;
calculating a loss between the classification and discrimination result of the pre-training image and the image classification and discrimination label, to obtain pre-training loss information; and
updating the to-be-trained image discriminator network based on the pre-training loss information, to obtain an updated image discriminator network, using the updated image discriminator network as the to-be-trained image discriminator network, and returning to iteratively perform the operation of obtaining a pre-training image and an image classification and discrimination label, until the initial image discriminator network is obtained when a pre-training completion condition is reached.

20. The computer device according to claim 14, wherein the obtaining a training image comprises:
obtaining a target image, and inputting the target image into a target image segmentation model to perform image segmentation and identification, to obtain a mask image;
performing mask area division based on the mask image to obtain each image area; and
using each image area as the training image.
